(19) United States
(12) Patent Application Publication
(10) Pub. No.: US 2008/0168509 A1
(43) Pub. Date: Jul. 10, 2008

(54) METHODS, SYSTEMS, AND COMPUTER PROGRAM PRODUCTS FOR PROVIDING CENTRALIZED MEDIA RECORDING, MANAGEMENT, AND REPLAY SERVICES FOR MULTI-PLATFORM MEDIA DEVICES

(75) Inventors: Ke Yu, Alpharetta, GA (US); Buddy Yaussy, Duluth, GA (US)

Correspondence Address: CANTOR COLBURN LLP - BELLSOUTH, 20 Church Street, 22nd Floor, Hartford, CT, 06103, US

(73) Assignee: BELLSOUTH INTELLECTUAL PROPERTY CORPORATION, Wilmington, DE (US)

(21) Appl. No.: 11/620,190

(22) Filed: Jan. 5, 2007

(51) Int. Cl. H04N 7/173

(52) U.S. Cl. 725/93

(57) ABSTRACT

Methods, systems, and computer program products for providing media management services for multi-platform media devices are provided. The method includes receiving a first request from a media device for a media file via a network. The method also includes associating the media file with an account record established for an account holder specified in the first request. The method further includes recording the media file and identifying a device platform for the media device. The method also includes providing the media device with access to the recorded media file by converting the recorded media file to the device platform and streaming the converted, recorded media file to the media device over the network.

### BACKGROUND

The present invention relates generally to media management, and more particularly, to methods, systems, and computer program products for providing centralized media recording, management, and replay services for multi-platform media devices.

There are currently a wide variety of media devices on the market, such as televisions, cellular telephones, personal computers, MP3 players, and mobile personal digital assistants (PDAs), to name a few. Many of these media devices are capable of providing media generation, receipt, storage, and distribution functions. For example, video media files can be captured on a cellular telephone and viewed by a user, and audio music files may be downloaded and stored on an MP3 player for later access.

With finite storage capabilities associated with these devices, some users are turning to network-managed storage services in which users select media files to be stored on a network, thereby reducing the amount of memory required by the devices. However, network storage service providers typically restrict their services to a particular type of media (e.g., network photo libraries for digital (still) images; network-stored video programming, such as movies and television programs; etc.). This is at least in part, due to varying communications technologies and protocols utilized by different types of media devices. For example, a user of an Internet Protocol-enabled television may access content (e.g., television program) provided over a broadband cable or digital subscriber line (DSL) network via a set top box coupled to the device. Likewise, another type of device, such as a cellular telephone, may access the same content over a cellular network using various wireless transmissions protocols. This may be inconvenient and time-consuming for a user who, e.g., possesses multiple cross-platform media devices and would like to access content via one or more of these media devices.

What is needed, therefore, is a way to provide multi-platform network storage and management of media content.

### BRIEF SUMMARY

Exemplary embodiments include a method for providing media management services for multi-platform media devices. The method includes receiving a first request from a media device for a media file via a network. The method also includes associating the media file with an account record established for an account holder specified in the first request. The method further includes recording the media file and identifying a device platform for the media device. The method also includes providing the media device with access to the recorded media file by converting the recorded media file to the device platform and streaming the converted, recorded media file to the media device over the network.

Additional exemplary embodiments include a system for providing media management services for multi-platform media devices. The system includes a host system and a media management application executing on the host system. The media management application implements a method. The method includes receiving a first request from a media device for a media file via a network. The method also includes associating the media file with an account record established for an account holder specified in the first request. The method further includes recording the media file and identifying a device platform for the media device. The method also includes providing the media device with access to the recorded media file by converting the recorded media file to the device platform and streaming the converted, recorded media file to the media device over the network.

Further exemplary embodiments include a computer program product for providing media management services for multi-platform media devices. The computer program product includes instructions for causing a computer to implement a method. The method includes receiving a first request from a media device for a media file via a network. The method also includes associating the media file with an account record established for an account holder specified in the first request. The method further includes recording the media file and identifying a device platform for the media device. The method also includes providing the media device with access to the recorded media file by converting the recorded media file to the device platform and streaming the converted, recorded media file to the media device over the network.

Other systems, methods, and/or computer program products according to embodiments will be or become apparent to one with skill in the art upon review of the following drawings and detailed description. It is intended that all such additional systems, methods, and/or computer program products be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 is a block diagram depicting a system upon which media management services may be implemented in accordance with exemplary embodiments;

FIG. 2 is a flow diagram describing a process for implementing the media management services in accordance with exemplary embodiments; and

FIG. 3 is a sample account record generated by the media management services in exemplary embodiments.

The detailed description explains the exemplary embodiments, together with advantages and features, by way of example with reference to the drawings.

### DETAILED DESCRIPTION OF EXEMPLARY EMBODIMENTS

Centralized media recording, management, and replay services (collectively referred to herein as “media management services”) for multi-platform media devices are provided in accordance with exemplary embodiments. The media management services record media content upon request, and provide storage of (and access to) a single copy of the recorded media content by multiple, disparate media devices over a network. The media content is converted for each type of media device prior to streaming the media content to the media device. Accounts may be established that identify each user and media device associated with a group (e.g., members of a household) for which the media management services are provided. The accounts enable users to select media for recording and to determine when, and under what conditions, to delete the recorded media files from storage. In one exemplary embodiment, the media management services provide digital video recording (DVR) functionality to a legacy (e.g., non-DVR) set top box (STB) communicatively coupled to a television.

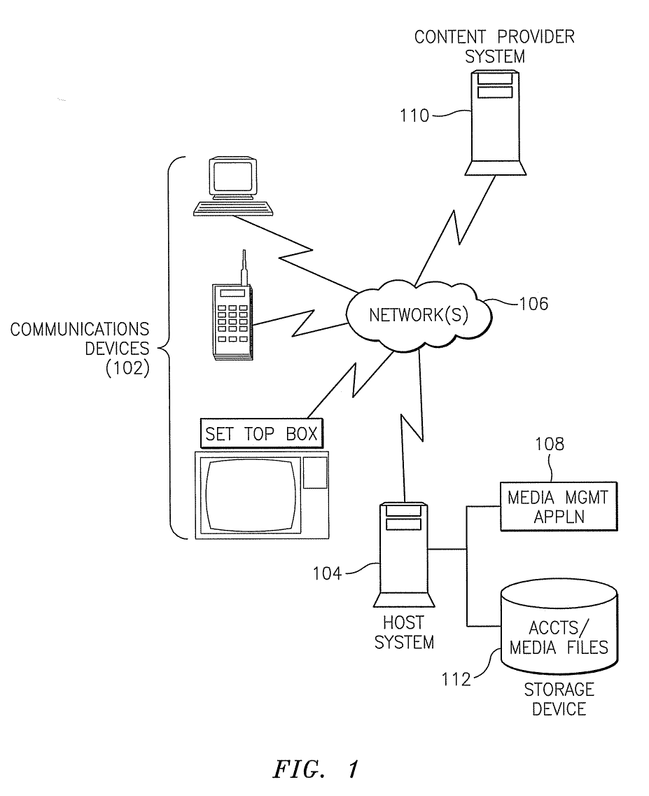

Turing now to FIG. 1, a system upon which the media management services may be implemented will now be described in accordance with exemplary embodiments. The system of FIG. 1 includes media devices 102 in communication with a host system 104 over one or more networks 106. In addition, the host system 104 is in communication with a content provider system 110 via networks 106.

Media devices 102 may include wireless or wireline computer devices such as a personal computer or laptop. With the proper tools (e.g., an Internet service subscription and modem, the media devices 102 may communicate over a packet-switched network, such as networks 106. The media devices 102 may be a personal computer (e.g., desktop, laptop) that communicates over networks 106 using an Internet service provider (ISP). The media devices 102 may also communicate over the Internet utilizing, e.g., digital subscriber line (DSL), cable, dial-up, etc. communications protocols.

Alternatively, or in addition thereto, media devices 102 may include a wireless mobile device, such as a cellular telephone, personal digital assistant (PDA) or similar wireless mobile computer-processing device, and/or wireless mobile telephones. Under a subscription agreement with a wireless service provider, the media devices 102 may communicate over networks 106 (e.g., satellite, radio, and/or cellular technologies) via wireless communications protocols, such as Bluetooth, WAP, WiFi, etc.), and/or other known networking technologies.

In exemplary embodiments, media devices 102 are equipped with DVR functionality. Users of media devices 102 may access program schedules and preset the recording of one or more programs via the media management services (e.g., a user interface provided by the media management services). The recording may come from multiple sources (e.g., multiple channels) and multiple programs may be simultaneously recorded. The media management services monitors the recording activities and provides capabilities to optimize bandwidth usage for the media devices 102, shift recording times, resolve scheduling conflicts, notify users about the status of recordings, and provide real time playback of recordings. The bandwidth usage may be optimized by recording a program at multiple rates and resolutions for varying media device platforms and identifying the optimal rates and resolutions for a particular device. Media device platforms dictate the operational requirements required to implement each of the respective devices. By way of one example, a small portable media device (e.g., PDA) may utilize different communications/applications/transmission protocols than would a desktop computer with greater memory, processing and data transmission capabilities.

In exemplary embodiments, a client application may be implemented at the media devices 102 and used to negotiate with the media management services to identify the proper configuration and to establish connections with the appropriate video stream and cast mode (e.g., unicast, multicast, or broadcast).

Host system 104 executes computer instructions for performing media management services. The system depicted in FIG. 1 includes one or more media devices 102 through which users, who may be at one or more geographic locations, may contact the host system 104. The media devices 102 may be coupled to the host system 104 via networks 106.

Content provider system 110 may be a provider of media content, e.g., broadcast television service provider, premium channel service provider, Web content provider, over-the-air or satellite radio provider system, etc.

Each of host system 104 and content provider system 110 may be implemented using one or more servers operating in response to a computer program stored in a storage medium accessible by the server. The host system 104 and content provider system 110 may operate as network servers (e.g., a web server) to communicate with the media devices 102. The host system 104 and content provider system 110 handle sending and receiving information to and from each other, as well as to and from the media devices 102 and can perform associated tasks. The host system 104 and content provider system 110 may also include firewalls to prevent unauthorized access and enforce any limitations on authorized access.

The host system 104 and content provider system 110 may also operate as application servers. The content provider system 110 may implement logic for providing content (e.g., Web pages, messaging, etc.) to one or more media devices 102. The host system 104 executes one or more computer programs to implement the media management services. These one or more computer programs are referred to herein as a media management application 108.

In exemplary embodiments, the host system 104 is in communication with a storage device 112. Storage device 112 includes a data repository with data relating to the media management services and may be implemented using a variety of devices for storing electronic information. It is understood that the storage device 112 may be implemented using memory contained in the host system 104 or that it may be a separate physical device. The storage device 112 may be logically addressable as a consolidated data source across a distributed environment that includes networks 106. Information stored in the storage device 112 may be retrieved and manipulated via the host system 104 and/or via the media devices 102. The data repository includes one or more databases containing, e.g., account records, and media content (e.g., media files).

In accordance with exemplary embodiments, media files include any representation of media content, such as a transmitted or stored audio signal, video signal, or image signal, and multi-media signal, for example. In exemplary embodiments, the media file is a video media file. In another embodiment, the media file is a near real-time video media file. As used herein, the term “near-real time” shall refer to a nearly contemporaneous transmission and delivery of the media file, and that such delivery may include small delays as a result of transfer among multiple transmission paths.

Networks 106 may include any type of network including, but not limited to, a wide area network (WAN), a local area network (LAN), a global network (e.g. Internet), a virtual private network (VPN), and an intranet. The networks 106 may be implemented using a wireless network or any kind of physical network implementation known in the art.

The media management services provide the host system 104 with the ability to centralize the media recording, management, and replay services described herein. In addition, the media management services manage the recorded media and user accounts on the network (e.g., recording, playback, deletion, and usage tracking activities among viewers).

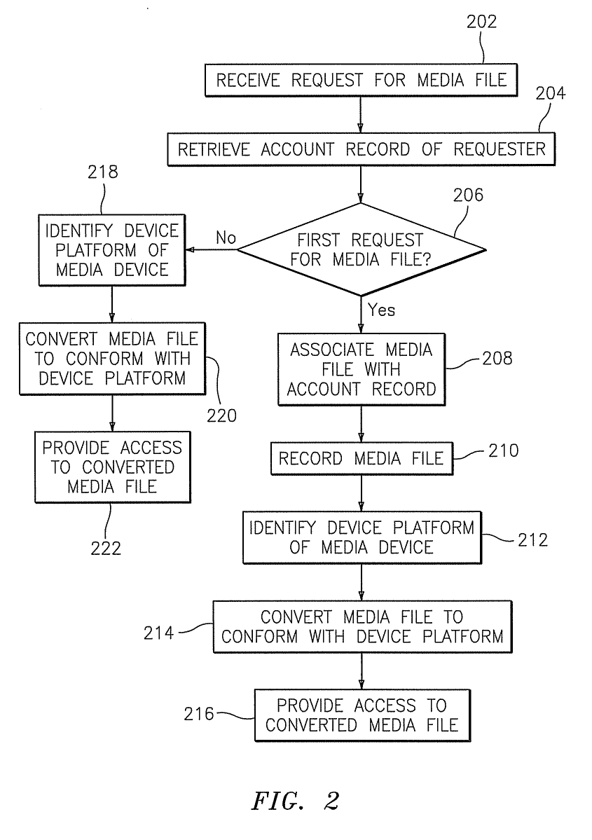

Turning now to FIG. 2, a flow diagram of a process for implementing the media management services will now be described in accordance with exemplary embodiments. At step 202, a request for a media file is received by the host system 104. The request may be sent by the media device 102 over networks 106. The request may include device platform information regarding the device 102. For example, the device platform information may include device capabilities, such as bandwidth and data rate capabilities. Further, as each type of media device 102 may utilize differing communications protocols (e.g., transport layer protocols, application-layer protocols, network protocols, and data transport protocols), the device platform information may include these communications protocols requirements for assisting the host system 104 in converting and streaming the recorded media files to the media devices 102.

In alternative exemplary embodiments, the device platform information may be stored in an account record established for the media devices 102. Other information may be presented in the request as well. For example, a network address of the media device requesting the media file may be transmitted via the request to the host system 104. Alternatively, this network address information may be provided during registration of the media management services (e.g., when an account for the media device is established) and stored in the account record for the account.

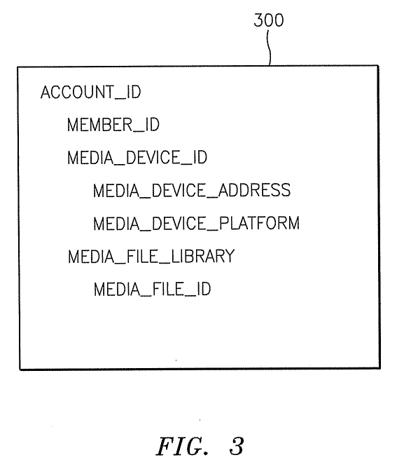

At step 204, the media management application 108 retrieves the account record associated with the request from storage device 112. A sample account record 300 is shown generally in FIG. 3.

Because only a single copy of a media file is saved for each account, at step 206, it is determined whether the request for the media file is the first request for this account. This may be determined by reviewing the account record and checking to see if the media file is already recorded and saved for the account.

If the request is the first request associated with a particular account for the media file, the media management application 108 associates the media file with the account record at step 208. For example, the association may include mapping an identifier for the media file with the account record using, e.g., a mapping key, such as an account identification. As shown in FIG. 3, a unique identifier assigned to the media file is listed in the account record. It will be appreciated that other methods of association may be utilized in realizing the advantages of the exemplary embodiments.

At step 210, the media file is recorded, e.g., from content provider system 110, and stored in storage device 112 or other repository in communication with the host system 104.

At step 212, a device platform is identified for the media device requesting the media file. As indicated above, this may be implemented by transmitting the device platform information from the media device 102 in the request. Alternatively, this information may be provided upon registration (e.g., upon establishing an account for media management services with the host system 104).

At step 214, the host system 104, via media management application 108, converts the recorded media file, if needed, to conform to the device platform of the requesting media device and provides access to the converted, recorded media file by streaming the media file from the storage device 112 over network 106 to the media device 102 at step 216.

Returning to step 206, if the request is not the first request for the media file (e.g., the media file is already stored in the storage device 112 for the account), the media management application 108 identifies the device platform of the media device (which may be a different media device than the original requesting media device) at step 218, converts the recorded media file, if needed, to conform to the device platform of the requesting media device at step 220, and provides access to the converted, recorded media file by streaming the media file from the storage device 112 over network 106 to the media device 102 at step 222.

As indicated above, a single copy of a media file may be stored in storage device 112 for an account. Upon request for access to the media file, the media management services determines the appropriate device platform and converts the media file, if needed, to the device platform corresponding to the requesting media device. The account may be established not only for multiple cross-platform media devices, but may also service multiple group members defined for the account (e.g., members of a household), as well as the cross-platform devices owned or used by these members.

The media management services provide a means for tracking and updating the media files stored for a particular account. Thus, a stored media file may be deleted if each member specified in an account submits a request to remove the media file.

As described above, the media management services provide the ability to enhance legacy set top boxes with DVR functionality, whereby media devices using differing platforms may simultaneously view a single recorded program. In addition, because only a single copy of a program is required and shared among multiple users and media devices, efficiencies of media storage, costs, and copyright management can be realized.

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A method for providing media management services for multi-platform media devices, comprising:
receiving a first request from a media device for a media file via a network;
associating the media file with an account record established for an account holder specified in the first request;
recording the media file;
identifying a device platform for the media device; and
providing the media device with access to the recorded media file by converting the recorded media file to the device platform and streaming the converted, recorded media file to the media device over the network.

2. The method of claim 1, further comprising:
receiving a second request from another media device for the media file via the network, the other media device associated with the account record;
retrieving the account record;
identifying a device platform for the other media device; and
providing the other media device with access to the recorded media file by converting the recorded media file to the device platform of the other media device and streaming the converted, recorded media file to the other media device over the network.

3. The method of claim 2, wherein the device platform of the media device is different than the device platform of the other media device; wherein device platforms dictate operational requirements associated with each type of media device.

4. The method of claim 1, further comprising:
deleting the recorded media file from storage when each account member identified in the account record has requested removal of the recorded media file.

5. The method of claim 1, further comprising:
receiving a client platform for each media device in the account record via at least one of:
a request for the media file by the media device; and
upon registration of the media device with the account record.

6. The method of claim 1, wherein the media device includes at least one of a(n):
Internet Protocol-enabled television;
personal computer;
wireless mobile telephone; and
wireless mobile personal computing device.

7. The method of claim 1, wherein the media file includes at least one of a(n):
audio file;
video file; and
multi-media file.

8. A system for providing media management services for multi-platform media devices, comprising:
a host system;
a media management application executing on the host system, the media management application implementing a method, comprising:
receiving a first request from a media device for a media file via a network;
associating the media file with an account record established for an account holder specified in the first request;
recording the media file;
identifying a device platform for the media device; and
providing the media device with access to the recorded media file by converting the recorded media file to the device platform and streaming the converted, recorded media file to the media device over the network.

9. The system of claim 8, wherein the media management application further performs:
receiving a second request from another media device for the media file via the network, the other media device associated with the account record;
retrieving the account record;
identifying a device platform for the other media device; and
providing the other media device with access to the recorded media file by converting the recorded media file to the device platform of the other media device and streaming the converted, recorded media file to the other media device over the network.

10. The system of claim 9, wherein the device platform of the media device is different than the device platform of the other media device; wherein device platforms dictate operational requirements associated with each type of media device.

11. The system of claim 8, wherein the media management application further performs:
deleting the recorded media file from storage when each account member identified in the account record has requested removal of the recorded media file.

12. The system of claim 8, wherein the media management application further performs:
receiving a client platform for each media device in the account record via at least one of:
a request for the media file by the media device; and
upon registration of the media device with the account record.

13. The system of claim 8, wherein the media device includes at least one of a(n):
Internet Protocol-enabled television;
personal computer;
wireless mobile telephone; and
wireless mobile personal computing device; and
wherein the media file includes at least one of a(n):
audio file;
video file; and
multi-media file.

14. A computer program product for providing media management services for multi-platform media devices, the computer program product including instructions for implementing a method, comprising:
receiving a first request from a media device for a media file via a network;
associating the media file with an account record established for an account holder specified in the first request;
recording the media file;
identifying a device platform for the media device; and
providing the media device with access to the recorded media file by converting the recorded media file to the device platform and streaming the converted, recorded media file to the media device over the network.

15. The computer program product of claim 14, further comprising instructions for implementing:
receiving a second request from another media device for the media file via the network, the other media device associated with the account record;
retrieving the account record;
identifying a device platform for the other media device; and
providing the other media device with access to the recorded media file by converting the recorded media file to the device platform of the other media device and streaming the converted, recorded media file to the other media device over the network.

16. The computer program product of claim 15, wherein the device platform of the media device is different than the device platform of the other media device; wherein device platforms dictate operational requirements associated with each type of media device.

17. The computer program product of claim 14, further comprising instructions for implementing:
deleting the recorded media file from storage when each account member identified in the account record has requested removal of the recorded media file.

18. The computer program product of claim 14, further comprising instructions for implementing:
receiving a client platform for each media device in the account record via at least one of:
a request for the media file by the media device; and
upon registration of the media device with the account record.

19. The computer program product of claim 14, wherein the media device includes at least one of a(n):
Internet Protocol-enabled television;
personal computer;
wireless mobile telephone; and
wireless mobile personal computing device.

20. The computer program product of claim 14, wherein the media file includes at least one of a(n):
audio file;
video file; and
multi-media file.
